(19) United States
(12) Patent Application Publication
(10) Pub. No.: US 2026/0277974 A1
(43) Pub. Date: Sep. 17, 2026

(54) HEADINGS BASED CHUNKING STRATEGY FOR SPECIFICATIONS DOCUMENTS

(71) Applicant: Autodesk, Inc., San Francisco, CA (US)

(72) Inventors: Vikas Sakaray, Bengaluru (IN); Sasikanth Bharadwaj Ammanamanchi, Bangalore (IN); Gopi Krishna Nuti, Bengaluru (IN); Varadarajulu Pyda, Ashburn, VA (US)

(73) Assignee: Autodesk, Inc., San Francisco, CA (US)

(21) Appl. No.: 19/561,153

(22) Filed: Mar. 9, 2026

Related U.S. Application Data
(60) Provisional application No. 63/773,341, filed on Mar. 17, 2025.

(51) Int. Cl. G06F 16/334; G06F 16/335

(52) U.S. Cl. CPC G06F 16/3347; G06F 16/335

(57) ABSTRACT

A method and system provide the ability to process a construction domain query. A construction specification document that has textual content organized under multiple headings is obtained. The multiple headings in the textual content are identified. Each of the identified multiple headings is treated as a chunk and heading embeddings are generated and stored for each chunk. A user query is obtained. Based on the stored heading embeddings, the user query is performed within each of the chunks to retrieve relevant textual content from each chunk. The relevant textual content from each of the chunks is consolidated into a query response.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/773,341, filed on Mar. 17, 2025, with inventor(s) Vikas Sakaray, Sasikanth Bharadwaj Ammanamanchi, Gopi Krishna Nuti, and Varadarajulu Pyda, entitled “HEADINGS BASED CHUNKING STRATEGY FOR SPECIFICATIONS DOCUMENTS,” attorneys'docket number 30566.0639USP1.

This application is related to the following co-pending and commonly-assigned patent application, which application is incorporated by reference herein:

U.S. patent application Ser. No. 18/946,571 , filed on November, 13, 2024, with inventor(s) Surendran Subbiah, Mo Han, Vikas Sakaray, Varadarajulu Pyda, Patricia Keaney, Graham Michael Garland, Beatriz Chinelato Guerra, and Gopi Krishna Nuti, entitled “GENERATIVE ARTIFICIAL INTELLIGENCE (AI) CONSTRUCTION SPECIFICATION INTERFACE”, Attorney Docket No. 30566.0619USU1, which application claims the benefit under 35 U.S.C. Section 119(e) of the following co-pending and commonly-assigned U.S. provisional patent application(s), which is/are incorporated by reference herein: U.S. Provisional Application Ser. No. 63/598,341, filed on Nov. 13, 2023, with inventor(s) Surendran Subbiah, Mo Han, Theerath Geddada, Varadarajulu Pyda, Patricia Keaney, Graham Michael Garland, Beatriz Chinelato Guerra, and Gopi Krishna Nuti entitled “Generative Artificial Intelligence (AI) Specification Interface,” attorneys'docket number 30566.0619USP1.

### BACKGROUND OF THE INVENTION

### 1. Field of the Invention

The present invention relates generally to construction specifications, and in particular, to a method, apparatus, system, and article of manufacture for analyzing and accessing information in a construction specification using a headings based chunking strategy.

### 2. Description of the Related Art

Work/construction specifications are documents that cover detailed information on projects. They are often extremely long and detailed, making them difficult to parse, use and obtain meaningful information. Searches are often long and labor intensive. For example, if the construction specification document is 1000 pages and a user needs information on a particular faucet flow rate, it's likely going to take quite a bit of time to gather. There exists a need for a faster, more efficient way of obtaining information. In this regard, construction specifications are often broken down/analyzed in order to organize the specification data to enable quick and accurate information retrieval. Prior art methods for analyzing construction specifications are deficient in that some accuracy may be lost, the time to analyze the specification may exceed a desired threshold limit, and/or the resulting organizational structure is faulty in that it may fail to enable efficient and accurate searches. To better understand the problems of the prior art, a description of prior art specification analysis and retrieval may be useful.

It may be noted that construction data is used in various parts of the construction project lifecycle. Such construction data includes design data, planning data, project management data, etc. All data may be available in a single platform, but project teams doing day-to-day tasks are required to retrieve information (in real time) from different locations where the relevant data for that team is siloed. For example, various project teams may encounter issues happening in the field or with the design such as requests for information (RFIs) being received/logged into a system, schedules with upcoming activities, assets being installed, forms/checklists filled out by contractors, etc. In this regard, a contractor may need to determine open issues such as which RFIs need to be addressed before a crew arrives on a jobsite or whether specific information required for an RFI has been entered in the project/construction specification. In other words, relevant information for different aspects of a project is siloed within a construction system platform. What is needed is the capability to quickly and efficiently access the relevant information regardless of how/where it is siloed/stored within a construction system platform.

Chunking a document is a crucial step in analyzing construction specifications. Prior art methods perform the extracting and indexing process via a brute-force approach which was later identified to be less than ideal. Such prior art brute-force approaches impact the accuracy of the retrieved answers significantly. More specifically, in prior art methods, a construction specification document PDF (portable document format) is processed in a brute force manner-also referred to (by programmers) as a sliding window approach. In a sliding window approach, each page of the specification document is processed as the starting point. Every 1500 characters, or another chosen length, in the text is considered as a single chunk and the next 1500 characters are treated as another chunk. An overlap of 150 characters is maintained. This brute force approach often causes chunks to start or end in the middle of a sentence or breaking up a word in the middle. The sentences, being part of larger descriptive paragraphs and sections, often refer to either previous sentences or next sentences. The sliding window approach does not pay attention to this relationship and as a result, the chunks loose any meaning associated with the larger context. As an example, if one were to use the sliding window approach on Shakespeare's Hamlet, the result would end up with chunks “. . . to be o” and the next chunk being “r not to be . . . ”. This often destroys the meaning of the words and sentences there by resulting in poor performance in the downstream processes.

In the “Ask your specs” service (as described in the cross-referenced application above—available from the assignee of the present invention), specifications data is ingested into an open search index, and is used by a query service for retrieving relevant sections when the user asks a question. This ingestion involves two steps—(1) breaking up the section content into multiple chunks (referred to as “chunking”) and (2) generating vector representations for these chunks (referred to as “embeddings”) which are then stored as part of the document being ingested into the index. During retrieval, similar vector representations are created for the question input by the user and the top ranking documents whose vector representation matches that of the question are returned by the search API (application programming interface).

Current prior art chunking strategies go through section content by page, break the page text into fixed size chunks with a pre-defined overlap (e.g., 1000 characters per chunk, 200 character overlap), and then generate embeddings for these chunks. It has been observed that having well defined chunks works better in the sense that much better answers are generated if the retrieved chunks are well defined. However, as described above, such prior art fixed size chunking systems could split sentences/text at random locations resulting in meaningless chunks that negatively impacts the retrieval and accuracy of search results.

### SUMMARY OF THE INVENTION

Embodiments of the invention provide a unique approach to chunking a document. In particular, embodiments of the invention provide for chunking based on headings and the content of the heading.

### BRIEF DESCRIPTION OF THE DRAWINGS

Referring now to the drawings in which like reference numbers represent corresponding parts throughout:

FIG. 1 illustrates an overview of the details for chunking a construction specification in accordance with one or more embodiments of the invention;

FIG. 2 illustrates the logical flow for processing a construction domain query in accordance with one or more embodiments of the invention;

FIG. 3 is an exemplary hardware and software environment used to implement one or more embodiments of the invention; and

FIG. 4 schematically illustrates a typical distributed/cloud-based computer system used in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention focus on the fact that most specification documents are fairly well structured and have content organized under headings and subheadings. Embodiments treat each heading as a chunk. The result is that the chunks are well defined without overlap and consequently, the retrieved results are more accurate than prior art chunking mechanisms.

### Embodiment Details

In embodiments of the invention, the following methodology may be followed:
(1) The section level text that is obtained (e.g., as indicated in the application cross-referenced above) is broken down into heading levels. Each section heading in the text and the content of the heading (paragraphs and sentences) are treated as a single chunk whose length is below a predefined value. In embodiments of the invention, an ACC (AUTODESK CONSTRUCTION CLOUD™) Autospecs algorithm (a tool that automates the creation of submittal logs by scanning construction specification documents) may be utilized to identify the headings and sub-headings in given text. In an extremely rare case of sections having very long text (paragraphs or sentences) that are longer than the predefined value, the sentence sizes may be adjusted to suit the length and/or a sliding window may be employed.

This step (1) yields chunks that are at a section level with complete sentences. Thus, the complete contextual meaning is preserved.
(2) The chunks are grouped as per the section and heading. In other words, the headings are treated as chunks.
(3) Embeddings are generated for each chunk. In other words, the chunks are processed via an embedding generation algorithm that generates indices for each chunk.
(4) The embeddings/indices are then stored in an index (e.g., an OpenSearch index).
(5) Further processing may be performed similar to that described in the cross-referenced application.

Based on the above approach, embodiments of the invention significantly improve the accuracy of the answer generated for the user (i.e., prior art systems utilize a brute force approach where sentences may be split at random locations resulting in meaningless chunks—negatively impacting the retrieval and accuracy of any search of the specification).

Further to the above, chunking of embodiments of the invention add intelligence over the prior art and improves accuracy by a significant percentage. More specifically, embodiments of the invention add at least one or more of the following capabilities: (1) cleaner and higher quality chunks; (2) better answers; (3) complete answers as chunks don't start/end at random places mid-sentence; and (4) neat references are shown to the user to provide better explainability of the solution and improve the user's trust in it.

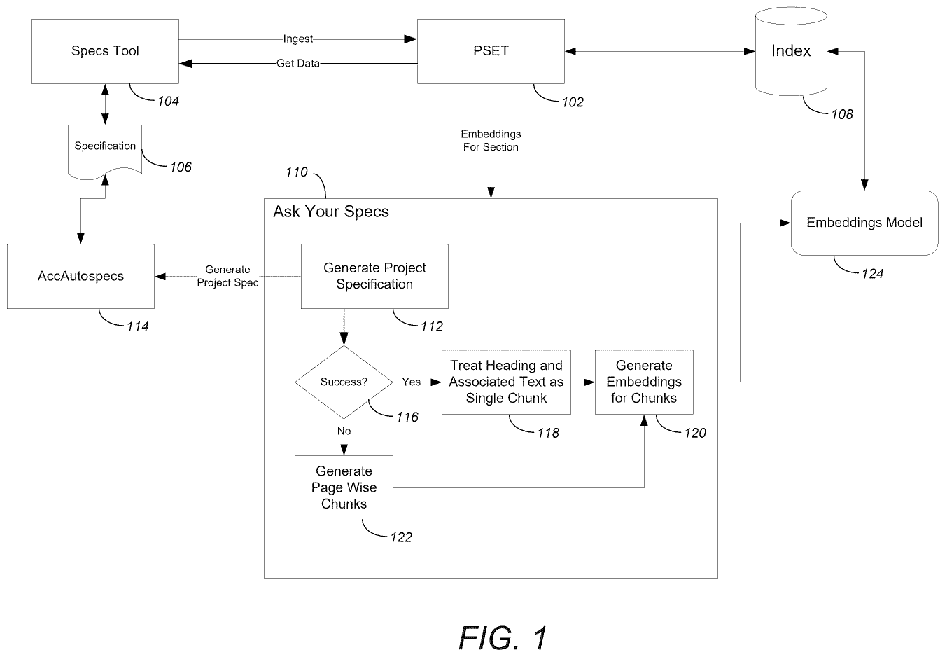

FIG. 1 illustrates an overview of the details for chunking a construction specification in accordance with one or more embodiments of the invention. A PSET system/application 102 may issue a request to get data from a specifications tool 104 which then ingests data from a construction specification(s). In this regard, the specifications tool 104 automatically sections specification documents 106 for easy navigation throughout the project lifecycle. As used herein, the PSET system/application 102 may also be referred to as a vector store and/or search service that is used to enable the analysis, storage, and search of data from a construction specification 106 (e.g., via a specification tool 104). The information received/generated by/within the PSET application 102 is stored in an index 108.

As described above, in the prior art, the ingestion of the data involves two steps: (1) breaking up the section content into multiple chunks (chunking); and (2) generating vector representations for these chunks (embeddings) that are then stored as part of the document 106 being ingested into the index 108. During retrieval (e.g., via the Ask Your Specs tool 110), similar vector representations (embeddings) are created for the question input by the user and the top ranking documents whose vector representation matches that of the question are returned by the search API.

In contrast to the prior art, embodiments of the invention recognize that most specification documents 106 are fairly well structured and have content organized under headings and sub-headings. Accordingly, embodiments of the invention treat each heading as a chunk resulting in chunks that are well defined without overlap. The first step in such a process is to identify the headings and subheadings in given text. In embodiments of the invention, the Ask Your Specs tool includes a function 112 to generate a project specification. The function 112 uses the ACC AutoSpecs™ algorithm 114 to identify the headings and sub-headings from the text in a specification document 106. The ACC AutoSpecs™ algorithm 114 is an algorithm/function that enables the creation of detailed and accurate submittal logs that can bed published for documentation and construction teams for use by a project team.

If the algorithm 114 successfully identifies the headings and sub-headings (as determined at step 116), the headings are obtained from the project specification 106 and each heading and associated text is treated as a single chunk at step 118. Embeddings are then generated for the chunks at step 120.

The embeddings are then stored in the PSET index 108 via the embeddings model 122.

As a fallback mechanism, if the ACCAutoSpecs algorithm 114 returns an error or fails to identify any headings in the given text for whatever reason (i.e., it is unsuccessful as determined at step 116), embodiments of the invention employ the page wise chunking strategy with character overlap (i.e., to generate page wise chunks at step 124). The same fallback (step 124) is also used if the heading is too large and is likely to exceed the token limit imposed by the embedding model 122. Similar to when headings/subheadings have been identified, once chunks have been generated at step 124, embedding for the chunks are generated at step 120 and stored in the PSET index 108 via embeddings model 122.

### Logical Flow

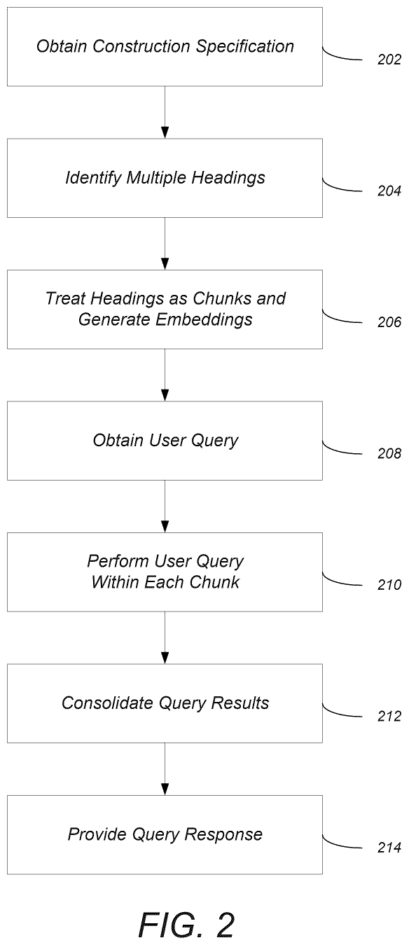

FIG. 2 illustrates the logical flow for processing a construction domain query in accordance with one or more embodiments of the invention.

At step 202, a construction specification document is obtained. The construction specification document comprises/consists of textual content organized under multiple headings.

At step 204, multiple headings are identified in the textual content. IN one or more embodiments, a size of one or more of the multiple headings is within a predefined size threshold imposed by an embedding model.

At step 206, for each of the identified multiple headings, each of the identified multiple headings is treated as a chunk, and one or more heading embeddings are generated (for each chunk). The one or more heading embeddings comprise/consist of vector representations. The heading embeddings for each chunk are then stored in an index.

At step 208, a user query is obtained.

At step 210, based on the stored heading embeddings, the user query is performed within each of the chunks to retrieve relevant textual content from each chunk. In one or more embodiments, to perform the query, query embeddings that comprise vector representations are generated and then compared to the stored heading embeddings. Thereafter, textual content whose stored heading embeddings match the query embeddings are retrieved.

In one or more additional embodiments, in performing the user query, the user query is pre-processed to validate the query. Text from the preprocessed user query is embed into search vectors for a semantic search. The semantic search is then performed within each of the chunks, based on the search vectors and the stored heading embeddings. The semantic search identifies semantically relevant sections of the chunks. The semantically relevant sections of the chunks are then consolidated into a contextual data prompt. A large language model (LLM) may then be used to generate a response based on the contextual data prompt. The LLM may be trained based on construction data that comprises/consists of multiple different data that is siloed within the construction software system. The response identifies the semantically relevant chunks. The response and identification of the semantically relevant chunks are then output.

At step 212, the relevant textual content from each of the chunks is consolidated into a query response.

At step 214, the query response is provided (e.g., to the user).

In embodiments of the invention, steps 202-214 may be repeated for additional construction specification documents (e.g., that contain textual content). In one such repeated sequence, the application fails to identify, in the textual content, any headings. Alternatively, a determination may be made that a size of at least one or more of the multiple headings exceeds a predefined size threshold imposed by an embedding model. As a result, as a fallback mechanism, the textual content is processed by page. The textual content on each page is then broken into fixed size chunks with a pre-defined overlap. The pre-defined overlap is based on a defined number of characters (e.g., 1000 characters) per chunk, and a defined number of characters (e.g., 200 characters) that overlap. Thereafter, textual embeddings for each fixed size chunk are generated (with each textual embedding comprises/consisting of a vector representation). The user query is then processed based on the textual embeddings for the fixed size chunks.

### Hardware Environment

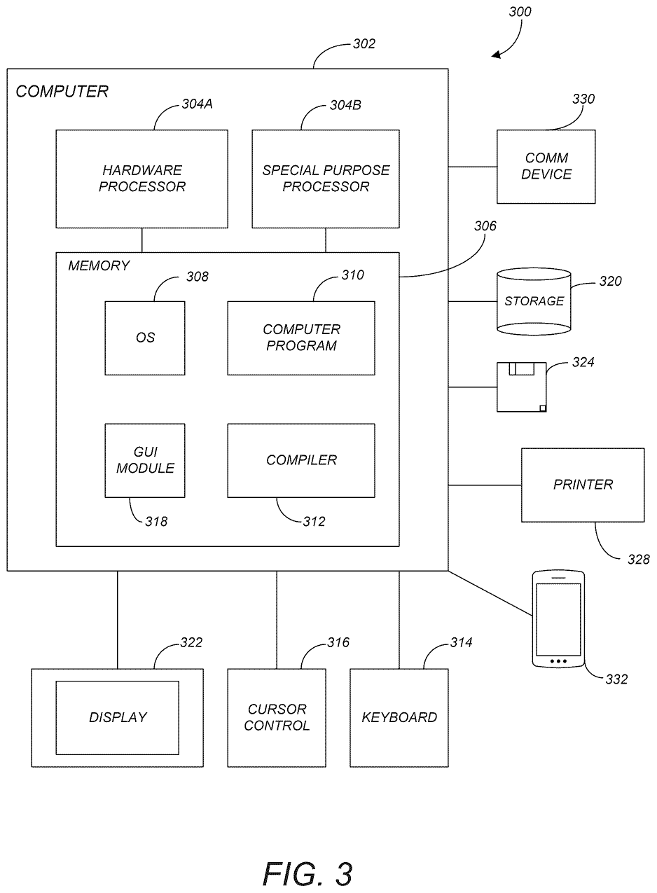

FIG. 3 is an exemplary hardware and software environment 300 (referred to as a computer-implemented system and/or computer-implemented method) used to implement one or more embodiments of the invention. The hardware and software environment includes a computer 302 and may include peripherals. Computer 302 may be a user/client computer, server computer, or may be a database computer. The computer 302 comprises a hardware processor 304A and/or a special purpose hardware processor 304B (hereinafter alternatively collectively referred to as processor 304) and a memory 306, such as random access memory (RAM). The computer 302 may be coupled to, and/or integrated with, other devices, including input/output (I/O) devices such as a keyboard 314, a cursor control device 316 (e.g., a mouse, a pointing device, pen and tablet, touch screen, multi-touch device, etc.) and a printer 328. In one or more embodiments, computer 302 may be coupled to, or may comprise, a portable or media viewing/listening device 332 (e.g., an MP3 player, IPOD, NOOK, portable digital video player, cellular device, personal digital assistant, etc.). In yet another embodiment, the computer 302 may comprise a multi-touch device, mobile phone, gaming system, internet enabled television, television set top box, or other internet enabled device executing on various platforms and operating systems.

In one embodiment, the computer 302 operates by the hardware processor 304A performing instructions defined by the computer program 310 (e.g., a computer-aided design [CAD] application) under control of an operating system 308. The computer program 310 and/or the operating system 308 may be stored in the memory 306 and may interface with the user and/or other devices to accept input and commands and, based on such input and commands and the instructions defined by the computer program 310 and operating system 308, to provide output and results.

Output/results may be presented on the display 322 or provided to another device for presentation or further processing or action. In one embodiment, the display 322 comprises a liquid crystal display (LCD) having a plurality of separately addressable liquid crystals. Alternatively, the display 322 may comprise a light emitting diode (LED) display having clusters of red, green and blue diodes driven together to form full-color pixels. Each liquid crystal or pixel of the display 322 changes to an opaque or translucent state to form a part of the image on the display in response to the data or information generated by the processor 304 from the application of the instructions of the computer program 310 and/or operating system 308 to the input and commands. The image may be provided through a graphical user interface (GUI) module 318. Although the GUI module 318 is depicted as a separate module, the instructions performing the GUI functions can be resident or distributed in the operating system 308, the computer program 310, or implemented with special purpose memory and processors.

In one or more embodiments, the display 322 is integrated with/into the computer 302 and comprises a multi-touch device having a touch sensing surface (e.g., track pod, touch screen, smartwatch, smartglasses, smartphones, laptop or non-laptop personal mobile computing devices) with the ability to recognize the presence of two or more points of contact with the surface. Examples of multi-touch devices include mobile devices (e.g., IPHONE, ANDROID devices, WINDOWS phones, GOOGLE PIXEL devices, NEXUS S, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 302 according to the computer program 310 instructions may be implemented in a special purpose processor 304B. In this embodiment, some or all of the computer program 310 instructions may be implemented via firmware instructions stored in a read only memory (ROM), a programmable read only memory (PROM) or flash memory within the special purpose processor 304B or in memory 306. The special purpose processor 304B may also be hardwired through circuit design to perform some or all of the operations to implement the present invention. Further, the special purpose processor 304B may be a hybrid processor, which includes dedicated circuitry for performing a subset of functions, and other circuits for performing more general functions such as responding to computer program 310 instructions. In one embodiment, the special purpose processor 304B is an application specific integrated circuit (ASIC).

The computer 302 may also implement a compiler 312 that allows an application or computer program 310 written in a programming language such as C, C++, Assembly, SQL, PYTHON, PROLOG, MATLAB, RUBY, RAILS, HASKELL, or other language to be translated into processor 304 readable code. Alternatively, the compiler 312 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 310 accesses and manipulates data accepted from I/O devices and stored in the memory 306 of the computer 302 using the relationships and logic that were generated using the compiler 312.

The computer 302 also optionally comprises an external communication device such as a modem, satellite link, Ethernet card, or other device for accepting input from, and providing output to, other computers 302.

In one embodiment, instructions implementing the operating system 308, the computer program 310, and the compiler 312 are tangibly embodied in a non-transitory computer-readable medium, e.g., data storage device 320, which could include one or more fixed or removable data storage devices, such as a zip drive, floppy disc drive 324, hard drive, CD-ROM drive, tape drive, etc. Further, the operating system 308 and the computer program 310 are comprised of computer program 310 instructions which, when accessed, read and executed by the computer 302, cause the computer 302 to perform the steps necessary to implement and/or use the present invention or to load the program of instructions into a memory 306, thus creating a special purpose data structure causing the computer 302 to operate as a specially programmed computer executing the method steps described herein. Computer program 310 and/or operating instructions may also be tangibly embodied in memory 306 and/or data communications devices 330, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 302.

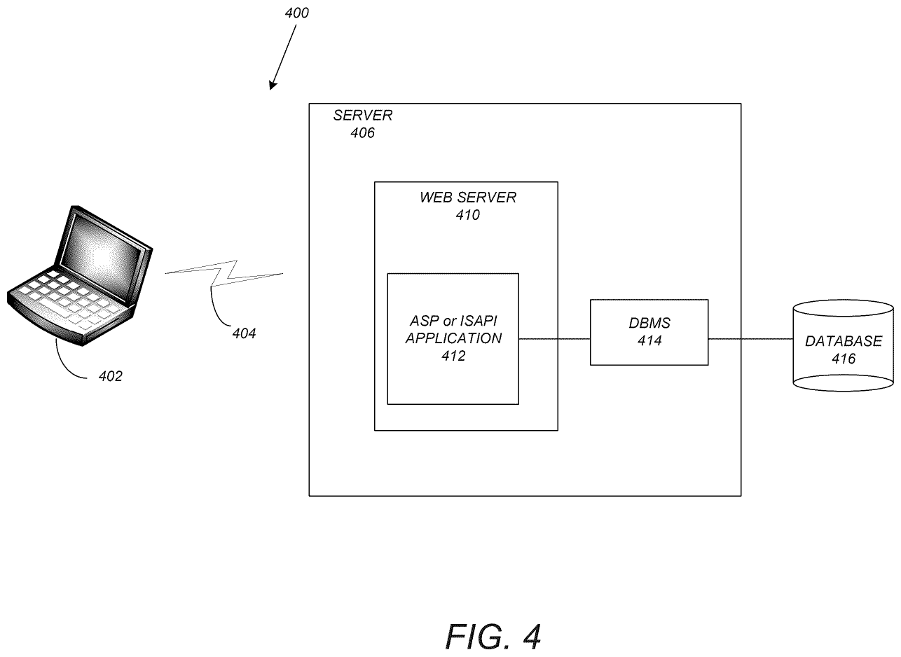

FIG. 4 schematically illustrates a typical distributed/cloud-based computer system 400 using a network 404 to connect client computers 402 to server computers 406. A typical combination of resources may include a network 404 comprising the Internet, LANs (local area networks), WANs (wide area networks), SNA (systems network architecture) networks, or the like, clients 402 that are personal computers or workstations (as set forth in FIG. 3), and servers 406 that are personal computers, workstations, minicomputers, or mainframes (as set forth in FIG. 3). However, it may be noted that different networks such as a cellular network (e.g., GSM [global system for mobile communications] or otherwise), a satellite based network, or any other type of network may be used to connect clients 402 and servers 406 in accordance with embodiments of the invention.

A network 404 such as the Internet connects clients 402 to server computers 406. Network 404 may utilize ethernet, coaxial cable, wireless communications, radio frequency (RF), etc. to connect and provide the communication between clients 402 and servers 406. Further, in a cloud-based computing system, resources (e.g., storage, processors, applications, memory, infrastructure, etc.) in clients 402 and server computers 406 may be shared by clients 402, server computers 406, and users across one or more networks. Resources may be shared by multiple users and can be dynamically reallocated per demand. In this regard, cloud computing may be referred to as a model for enabling access to a shared pool of configurable computing resources.

Clients 402 may execute a client application or web browser and communicate with server computers 406 executing web servers 410. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 402 may be downloaded from server computer 406 to client computers 402 and installed as a plug-in or ACTIVEX control of a web browser. Accordingly, clients 402 may utilize ACTIVEX components/component object model (COM) or distributed COM (DCOM) components to provide a user interface on a display of client 402. The web server 410 is typically a program such as MICROSOFT'S INTERNET INFORMATION SERVER.

Web server 410 may host an Active Server Page (ASP) or Internet Server Application Programming Interface (ISAPI) application 412, which may be executing scripts. The scripts invoke objects that execute business logic (referred to as business objects). The business objects then manipulate data in database 416 through a database management system (DBMS) 414. Alternatively, database 416 may be part of, or connected directly to, client 402 instead of communicating/obtaining the information from database 416 across network 404. When a developer encapsulates the business functionality into objects, the system may be referred to as a component object model (COM) system. Accordingly, the scripts executing on web server 410 (and/or application 412) invoke COM objects that implement the business logic. Further, server 406 may utilize AWS' (Amazon™ Web Service™) Open Search Service to access required data stored in database 416 via an interface such as ADO (Active Data Objects), OLE DB (Object Linking and Embedding DataBase), or ODBC (Open DataBase Connectivity).

Generally, these components 400-416 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 402 and 406 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 402 and 406. Embodiments of the invention are implemented as a software/CAD application on a client 402 or server computer 406. Further, as described above, the client 402 or server computer 406 may comprise a thin client device or a portable device that has a multi-touch-based display.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

As described above, embodiments of the invention provide for a new method and system for chunking a construction specification document for generating embeddings (to be used to search the document). Prior art systems break section content into multiple chunks (chunking) and generate vector representations for these chunks (embeddings) that are then stored as part of the document being ingested into an index. Prior art chunking utilizes a brute force approach going through section content be page, breaks the page text into fixed size chunks with a pre-defined overlap and then generates embeddings for these chunks. However, such prior art sections can be very long (spanning multiple pages) or very short (only a few words). It is desirable to handle both cases while obtaining the same length of embeddings. In contrast, embodiments of the invention identifies headings and sub-headings in given text, treats the headings as chunks, and generates embedding for each chunk and stores these in the index. As a result, embodiments of the invention provide cleaner and higher quality chunks, and better answers (from queries) compared to that of the prior art. Further, embodiments of the invention provide complete answers as the chunks don't start/end at random places mid-sentence. In addition, embodiments of the invention display references to the user to provide explainability of the solution and improve a user's trust in the solution.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for processing a construction domain query, comprising:
(a) obtaining a construction specification document, wherein the construction specification document comprises textual content organized under multiple headings;
(b) identifying, in the textual content, the multiple headings;
(c) for each of the identified multiple headings:
(1) treating each of the identified multiple headings as a chunk;
(2) generating one or more heading embeddings for each chunk, wherein the one or more heading embeddings comprise vector representations;
(3) storing the heading embeddings for each chunk in an index;
(d) obtaining a user query;
(e) performing, based on the stored heading embeddings, the user query within each of the chunks to retrieve relevant textual content from each chunk;
(f) consolidating the relevant textual content from each of the chunks into a query response; and
(g) providing the query response.

2. The computer-implemented method of claim 1, wherein the performing the user query comprises:
generating, based on the user query, query embeddings that comprise vector representations;
comparing the query embeddings to the stored heading embeddings; and
retrieving textual content whose stored heading embeddings match the query embeddings.

3. The computer-implemented method of claim 1, wherein the performing the user query comprises:
pre-processing the user query to validate the query;
embedding text from the preprocessed user query into search vectors for a semantic search;
performing the semantic search within each of the chunks, based on the search vectors and the stored heading embeddings, wherein the semantic search identifies semantically relevant sections of the chunks;
consolidating the semantically relevant sections of the chunks into a contextual data prompt;
utilizing a large language model (LLM) to generate a response based on the contextual data prompt, wherein the LLM is trained based on construction data, wherein the construction data comprises multiple different data that is siloed within the construction software system, and wherein the response identifies the semantically relevant chunks; and
outputting the response and identification of the semantically relevant chunks.

4. The computer-implemented method of claim 1, wherein:
a size of one or more of the multiple headings is within a predefined size threshold imposed by an embedding model.

5. The computer-implemented method of claim 1, further comprising:
obtaining an additional construction specification document, wherein the additional construction specification document comprises textual content;
failing to identify, in the textual content, any headings;
processing the textual content by page;
breaking the textual content on each page into fixed size chunks with a pre-defined overlap;
generating textual embeddings for each fixed size chunk, wherein each textual embedding comprises a vector representation; and
processing the user query based on the textual embeddings for the fixed size chunks.

6. The computer-implemented method of claim 5, wherein the pre-defined overlap is based on:
a defined number of characters per chunk; and
a defined number of characters that overlap.

7. The computer-implemented method of claim 1, further comprising:
obtaining an additional construction specification document, wherein the additional specification document comprises textual content organized under multiple headings;
determining that a size of at least one or more of the multiple headings exceeds a predefined size threshold imposed by an embedding model;
processing the textual content by page;
breaking the textual content on each page into fixed size chunks with a pre-defined overlap;
generating textual embeddings for each fixed size chunk, wherein each textual embedding comprises a vector representation; and
processing the user query based on the textual embeddings for the fixed size chunks.

8. The computer-implemented method of claim 7, wherein the pre-defined overlap is based on:
a defined number of characters per chunk; and
a defined number of characters that overlap.

9. A computer-implemented system for processing a construction domain query, comprising:
(a) a computer having a memory;
(b) a processor executing on the computer;
(c) the memory storing a set of instructions, wherein the set of instructions, when executed by the processor cause the processor to perform operations comprising:
(1) obtaining a construction specification document, wherein the construction specification document comprises textual content organized under multiple headings;
(2) identifying, in the textual content, the multiple headings;
(3) for each of the identified multiple headings:
(i) treating each of the identified multiple headings as a chunk;
(ii) generating one or more heading embeddings for each chunk, wherein the one or more heading embeddings comprise vector representations;
(iii) storing the heading embeddings for each chunk in an index;
(4) obtaining a user query;
(5) performing, based on the stored heading embeddings, the user query within each of the chunks to retrieve relevant textual content from each chunk;
(6) consolidating the relevant textual content from each of the chunks into a query response; and
(7) providing the query response.

10. The computer-implemented system of claim 9, wherein the operations performing the user query comprise:
generating, based on the user query, query embeddings that comprise vector representations;
comparing the query embeddings to the stored heading embeddings; and
retrieving textual content whose stored heading embeddings match the query embeddings.

11. The computer-implemented system of claim 9, wherein the operations performing the user query comprise:
pre-processing the user query to validate the query;
embedding text from the preprocessed user query into search vectors for a semantic search;
performing the semantic search within each of the chunks, based on the search vectors and the stored heading embeddings, wherein the semantic search identifies semantically relevant sections of the chunks;
consolidating the semantically relevant sections of the chunks into a contextual data prompt;
utilizing a large language model (LLM) to generate a response based on the contextual data prompt, wherein the LLM is trained based on construction data, wherein the construction data comprises multiple different data that is siloed within the construction software system, and wherein the response identifies the semantically relevant chunks; and
outputting the response and identification of the semantically relevant chunks.

12. The computer-implemented system of claim 9, wherein:
a size of one or more of the multiple headings is within a predefined size threshold imposed by an embedding model.

13. The computer-implemented system of claim 9, wherein the operations further comprise:
obtaining an additional construction specification document, wherein the additional construction specification document comprises textual content;
failing to identify, in the textual content, any headings;
processing the textual content by page;
breaking the textual content on each page into fixed size chunks with a pre-defined overlap;
generating textual embeddings for each fixed size chunk, wherein each textual embedding comprises a vector representation; and
processing the user query based on the textual embeddings for the fixed size chunks.

14. The computer-implemented system of claim 13, wherein the pre-defined overlap is based on:
a defined number of characters per chunk; and
a defined number of characters that overlap.

15. The computer-implemented system of claim 9, wherein the operations further comprise:
obtaining an additional construction specification document, wherein the additional specification document comprises textual content organized under multiple headings;
determining that a size of at least one or more of the multiple headings exceeds a predefined size threshold imposed by an embedding model;
processing the textual content by page;
breaking the textual content on each page into fixed size chunks with a pre-defined overlap;
generating textual embeddings for each fixed size chunk, wherein each textual embedding comprises a vector representation; and
processing the user query based on the textual embeddings for the fixed size chunks.

16. The computer-implemented system of claim 15, wherein the pre-defined overlap is based on:
a defined number of characters per chunk; and
a defined number of characters that overlap.
